(19) United States
(12) Patent Application Publication
(10) Pub. No.: US 2006/0265357 A1
(43) Pub. Date: Nov. 23, 2006

(54) Method of efficiently parsing a file for a plurality of strings

(76) Inventor: Matthew P. Potts, Citrus Heights, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/114,651

(22) Filed: Apr. 26, 2005

(51) Int. Cl. G06F 17/30

(52) U.S. Cl. 707/3

(57) ABSTRACT

A preferred embodiment of the method of the present invention parses a large computer file for a selected set of target strings in a manner whereby computing power is conserved and parsing speed is increased. The method parses for the selected set of target strings by initially writing a comprehensive regular expression that will return a match if any component of the target strings in the set are present in a line of the computer file. If a regular expression match is made in a line, string comparisons for all of the strings in the set of target strings are run for the line. The preferred embodiment preferably generates a log of all positive string comparisons that are made in the file.

### BACKGROUND OF THE INVENTION

The present invention generally relates to computer programming.

When writing code, there is a concept of regular expression matching which generally means defining a pattern that is to be searched and scanning each line of code at a time looking for the defined pattern. Such a search operation is generally known as parsing. Lines of code are separated from one another by a line return command.

A string is known to those of ordinary skill in the art as simply a list or set of characters. An uncomplicated example of a string is the letter h followed by the letter e, which is regarded as being a static expression. A regular expression is similar but can have wild cards in it, with a wild card being defined as a special character or character sequence which matches any character in a string comparison. Therefore, one can parse for a regular expression that comprises any letter followed by any number, or any number of characters in a row followed by a space. Thus, a regular expression can be considered to be more conceptual than a string. The parsing for a regular expression can also be considered to be a more powerful version of a string compare, basically because regular expressions can contain wild cards.

Because of these differences, a string compare operation is faster than a regular expression matching operation. Also, since regular expression parsing is more costly in terms of expending computing power, it is advantageous to perform string comparisons rather than regular expression pattern matching.

### SUMMARY OF THE INVENTION

A preferred embodiment of the method of the present invention parses a large computer file for a selected set of target strings in a manner whereby computing power is conserved and parsing speed is increased. The method parses for the selected set of target strings by initially writing a comprehensive regular expression that will return a match if any component of the target strings in the set are present in a line of the computer file. If a regular expression match is made in a line, string comparisons for all of the strings in the set of target strings are run for the line. The preferred embodiment preferably generates a log of all positive string comparisons that are made in the file.

### DESCRIPTION OF THE DRAWINGS

FIG. 1 is a flow chart of the preferred embodiment of the method of the present invention.

### DETAILED DESCRIPTION

The preferred embodiment of the method of the present invention parses a large computer file for a selected set of target strings in a manner whereby computing power is conserved and parsing speed is increased. The method is intended to parse or search a large computer file for a set of target strings in an efficient manner. In doing so, it characterizes or attempts to characterize every line by using a comprehensive pattern match to locate all substrings or components of the set of target strings that are to be found in the file, which may be extremely large. The comprehensive regular expression will identify each line in which a component of any one of the set of strings is located, and once found, will perform a string compare for all strings in the set for that line.

Each successful string compare will return the identification of the string which is then placed in a log of successful string comparisons, which preferably identifies the location and description of each successful string comparison in the file.

The method characterizes every line or attempts to characterize every line by using the results of a regular expression pattern match to run string comparisons against the set of strings to find all string comparison matches in each line. If and only if the pattern match is successful will string comparisons be run against the set of predetermined targets to find all matching strings of the original set of strings. If the regular expression does not match, or if the regular expression match is successful, but no string matches of the set are found, the line is ignored.

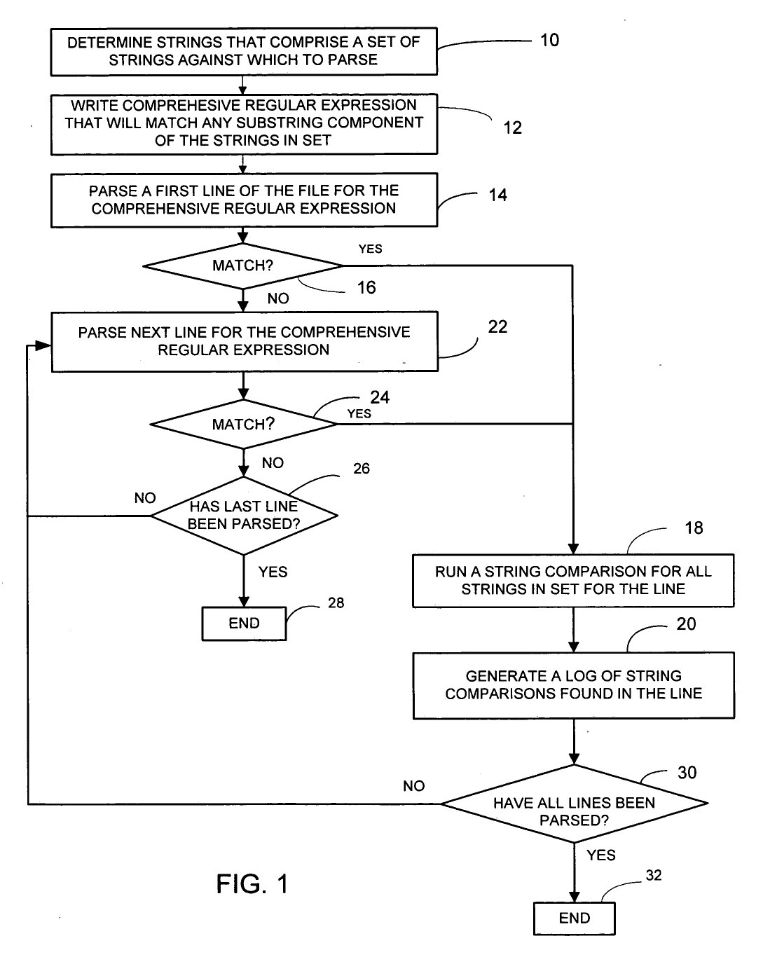

The preferred embodiment is illustrated in FIG. 1 where the strings that are of interest in the file are determined and therefore represent the targets which are the subject of parsing (block 10). A comprehensive regular expression is written that will match any substring component of the strings that comprises the set of strings (block 12). Such a comprehensive regular expression is known to those of ordinary skill in the art. After the comprehensive regular expression is written, the method then parses a first line for the comprehensive regular expression (block 14) and if a match is successful (block 16), a string comparison for all strings in the set is run for the line (block 18). If the match is not successful, then the next line is parsed for the regular expression (block 22). If that produces a match (block 24), then a string comparison for all strings in set is run for that line (block 18). If not, then the query is made if the last line has been parsed (block 26). If yes, the method is ended (block 28). If not, then the next line is parsed (block 22).

If the string comparison for all strings in the set for the line results in a match (block 18), then a log of the string comparisons is generated (block 20), which can comprise the specific identification of the string, together with the location, i.e., the line number in which it is located. Once that has been done, the query whether all lines have been parsed (block 30) is made, which if so, ends the string comparisons (block 32) and if not, returns to parse the next line (block 22).

This described embodiment has been advantageously used in a PERL scripting language, which is a coding language similar to C or C++. However, since it is not compiled, it is known to those skilled in the art as a scripting language. The language is useful in parsing results files from performing simulations on application specific integrated circuits (ASIC). The results files will contain information that indicate what happened during a simulation. The information can be extracted to determine the results of the simulation. Using the method described in the preferred embodiment, the time required to extract the information was reduced approximately 10 fold.

Parsing a file is a common practice, so the present invention is useful in many applications. The big O concept is known in the prior art as the upper bound for time required to complete a computer implemented operation. If there is only one variable, then the computation has a big O of N, because it is linear but not a constant. If only one variable exists, the size of the variable determines the length of time that is required to do the computation. If all that is required is to add many numbers together, that is a constant and would require substantially the same amount of time to do it every time, and the big-O would be a constant. If only regular expression matching is used to perform all parsing, the number of lines in the file, N, would be multiplied by the number of regular-expressions that have to be pattern-matched on every line, M, resulting in a big-O of N*M. With the preferred embodiment of the present invention, the big-O is again N because only one regular expression match (M=1) is done for every line. In the above example, the results were achieved on the order of 1*N rather than 10*N.

It should be understood that if the regular expression search does not reveal a match, then there is nothing more to be done, because the regular expression search is written in such a way that it would match anything that is expected to be found. Therefore, if there is no match in a line, there is no information that would be of interest with regard to the search.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method of parsing a computer file for a set of strings having a multiplicity of lines in a manner that conserves computing power and increases parsing speed, comprising the steps of:
determining individual strings that comprise the set of strings in the file against which parsing is to be run;
writing a comprehensive regular expression which will identify a line in which a substring of any string in the set of strings is present;
parsing a line of the file for said comprehensive regular expression;
running string comparisons against individual strings of said set of strings in said line if a match is successful for said comprehensive regular expression;
generating a log of successful string comparisons that are made for said line; and
repeating said parsing, running and generating steps for remaining lines of the file.

2. A method of parsing as defined in claim 1 wherein said step of generating a log further comprises identifying each string that is successfully compared and its location.

3. A method as defined in claim 1 wherein each of said strings comprises a list or set of characters.

4. A method as defined in claim 1 wherein each of said regular expressions comprises a list or set of characters that includes at least one wild card.

5. A method as defined in claim 4 wherein said wild card comprises a special character or character sequence which matches any character in a string comparison.

6. A method as defined in claim 1 wherein parsing an entire file for a string comparison requires substantially less computing time than parsing an entire for a regular expression match.

7. A method as defined in claim 6 wherein parsing an entire file for a string comparison requires less than 25% of the computing time that is required for parsing the entire file for a regular expression.

8. A method of searching for a set of strings in a computer file having a large number of lines, wherein the time required to complete the searching is significantly reduced, said method comprising the steps of:
determining the set of strings which are to be searched for in the file;
writing a comprehensive regular expression which will identify a line in which a substring of any string in the set of strings is present;
searching a first line of the file for said comprehensive regular expression;
running string comparisons against individual strings of the set of strings in said line if said comprehensive regular expression search is successful;
generating a log of successful string comparisons that are made for said line; and
repeating said searching, running and generating steps for the remaining lines of the file.

9. A method as defined in claim 8 wherein said required time is less than approximately 25 percent compared to conventional regular expression searching of said predetermined regular expressions.

10. A method of producing a log of the plurality of predetermined strings in a computer file having a plurality of lines, comprising the steps of:
writing a comprehensive regular expression which will identify a line in which a substring of any string in the plurality of strings is present;
searching a first line of the file for said comprehensive regular expression;
running string comparisons against individual strings of the plurality of strings in said line if said comprehensive regular expression search is successful;
generating a log of successful string comparisons that are made for said line; and
repeating said searching, running and generating steps for the remaining lines of the file.

11. A method as defined in claim 10 where said generating step further comprises adding the identity and location of each successful string comparison to said log file.

12. A computer program product comprising a computer usable medium having computer readable program code embodied in the medium for controlling the computer to parse for a set of strings in a file having a multiplicity of lines in a manner that conserves computing power and increases parsing speed by
determining individual strings that comprise the set of strings in the file against which parsing is to be run;
writing a comprehensive regular expression which will identify a line in which a substring of any string in the set of strings is present;
parsing a line of the file for said comprehensive regular expression;
running string comparisons against individual strings of said set of strings in said line if a match is successful for said comprehensive regular expression;
generating a log of successful string comparisons that are made for said line; and
repeating said parsing, running and generating steps for remaining lines of the file.
